(19) United States
(12) Patent Application Publication
(10) Pub. No.: US 2014/0125263 A1
(43) Pub. Date: May 8, 2014

(54) MOTOR CONTROLLER

(71) Applicant: MAGNA Electronics Europe GmbH & Co. KG, Sailauf (DE)

(72) Inventors: Mirko KRESS, Goldbach (DE); Thorsten MÜLLER, Hosbach (DE); Volker STEIGERWALD, Schollkrippen (DE)

(73) Assignee: MAGNA Electronics Europe GmbH & Co. KG, Sailauf (DE)

(21) Appl. No.: 14/070,553

(22) Filed: Nov. 3, 2013

(30) Foreign Application Priority Data
Nov. 5, 2012 (DE) DE 2012 220 123.8

(51) Int. Cl. H02P 7/00

(52) U.S. Cl. CPC H02P 7/00
USPC 318/400.13

(57) ABSTRACT

A system and a motor controller for a motor vehicle, the motor controller having electronics configured to bring about the energization of the windings of an electric motor. A clock generator is configured to send a clock signal which controls the processes of the electronics. The motor controller is operatively connected to a slave of a bus system in order to transmit and/or receive signals, and the clock of a clock signal being provided by the bus master is used via the slave to synchronize the clock generated by the clock generator of the motor controller.

### CROSS-REFERENCE TO RELATED APPLICATIONS

The present application claims priority 35 U.S.C. §119 to German Patent Publication No. DE 10 2012 220 123.8 (filed on Nov. 5, 2012), which is hereby incorporated by reference in its entirety.

### TECHNICAL FIELD

Embodiments relate to a motor controller for a motor vehicle, and may include electronics configured to bring about the energization of the windings of an electric motor, a clock generator configured to send a clock signal which controls the processes of the electronics, the motor controller being operatively connected to a slave of a bus system in order to transmit and/or receive signals, the clock of a clock signal being provided by the bus master may be used via the slave to synchronize the clock generated by the clock generator of the motor controller.

### BACKGROUND

Within motor vehicles, a plurality of devices are activated by way of brushless direct current motors. An example is the fan of a radiator by way of which air is conveyed through a heat exchanger.

German Patent Publication No. DE 10 2005 029 198 A1 discloses the control of a sliding door of a motor vehicle by way of an LIN bus and a slave ECU. The sliding door drive may be a DC brush motor or a brushless direct current motor, a BLDC motor.

A motor driver for an electronically commutated electric motor in accordance with German Patent Publication No. DE 196 10 994 A1 controls the generation of torque by way of a PWM signal.

German Patent Publication No. DE 42 00 477 C2 discloses an electric control device for brushless electric motors having a torque command signal generator, a time measuring circuit and meters.

German Patent Publication No. DE 60 030 623 T2 discloses a further way of controlling a BLDC motor in which voltage reading steps are carried out to sense the phase voltages.

German Patent Publication No. DE 10 2009 053 734 A1 discloses a method for synchronizing timers of the subscribers of a network.

German Patent Publication No. DE 10 2004 027 503 A1 discloses a method for establishing a global time base in a timed communication system.

A global time signal in a motor controller is disclosed in German Patent Publication No. DE 103 23 980 A1. Two communication bus systems are provided with different transmission speeds.

The manner of controlling a BLDC motor requires a clock, in which the control accuracy and compliance with a provided rotational speed depends on the accuracy of the clock signal, of the clock generator. The use of clock generators which comprise an oscillating quartz is known. In high temperature applications, such equipment is critical and costly. Alternatively, an RC oscillator with a high level of inaccuracy may be used.

### SUMMARY

In accordance with embodiments, a motor controller is provided having a design which is enhanced over the known solutions.

In accordance with embodiments, a motor controller for a motor vehicle, includes at least one of the following: electronics configured to bring about an energization of windings of an electric motor, a clock generator configured to send a clock signal which controls the processes of the electronics, wherein the motor controller is operatively connected to a slave of a bus system in order to transmit and/or receive signals, wherein the clock of a clock signal provided by the bus master is used via the slave to synchronize the clock signal generated by the clock generator of the motor controller.

In accordance with embodiments, a motor controller for a motor vehicle, includes at least one of the following: electronics configured to bring about an energization of windings of the electric motor; and a clock generator configured to send a clock signal which controls the electronics, wherein the motor controller is operatively connected to a slave of a bus system in order to transmit and/or receive signals; and a clock of the clock signal provided by a bus master is used via the slave to synchronize the clock generated by the clock generator of the motor controller.

In accordance with embodiments, a system includes at least one of the following: an electric motor; a controller having electronics configured to bring about an energization of windings of the electric motor, the controller including a clock generator configured to send a clock signal which controls the electronics, wherein the motor controller is operatively connected to a slave of a bus system in order to transmit and/or receive signals; and a clock of the clock signal provided by a bus master is used via the slave to synchronize the clock generated by the clock generator of the motor controller.

In accordance with embodiments, a system for a motor vehicle includes at least one of the following: a motor; a controller operatively connected to the motor and having electronics configured to bring about an energization of windings of the motor, the controller including a clock generator configured to send a clock signal which controls the electronics; and a bus system operatively connected to the controller, wherein a clock of the clock signal provided by a bus master is used via the slave to synchronize the clock generated by the clock generator of the controller.

In accordance with embodiments, an inaccurate clock of the motor controller repeatedly experiences synchronization by way of the bus system via which the motor controller is connected to the vehicle controller. The synchronization may be carried out by way of the master of the bus system which has very precise clocking, a correspondingly accurate clock generator.

In the field of motor vehicles, an LIN bus is used to control and connect modules for doors, steering wheels, seats, air-conditioning controllers, lighting systems, rain sensors, dynamos. Intelligent sensors and actuators may easily be connected to these modules by way of the LIN bus. The communication standard is under the CAN bus here.

In accordance with embodiments, the motor controller has a cost-effective clock generator which satisfies the ambient conditions, wherein the clock of this clock generator is synchronized at regular time intervals via the LIN slave which is connected to the controller. The cost-effective clock generator of the motor controller produces a clock signal with only a low level of accuracy, which correspondingly permits only a reduced level of system accuracy and rotational speed accuracy. By virtue of the successive synchronization of the clock of the motor controller with the high-precision clock of the LIN master, a higher level of system accuracy and rotational speed accuracy is therefore also achieved.

In accordance with the LIN specification, the clock of the LIN master has an accuracy <0.5%. The precise LIN clock (of the LIN master) is therefore used not only to synchronize the communication interface of the LIN bus (the LIN slave), but additionally also to enhance the clock of the motor controller via this interface. Embodiments, therefore, permit a high level of control accuracy without having to use a costly clock generator (Quartz). The motor controller may be equipped with a cost-effective RC oscillator.

### DRAWINGS

Embodiments will be illustrated by way of example in the drawings and explained in the description below.

FIG. 1 illustrates a bus system LB which is embodied as an LIN bus having a slave station LS.

FIG. 2 illustrates a graph of wave pulses generated by the clock generator of the motor controller plotted against time.

### DESCRIPTION

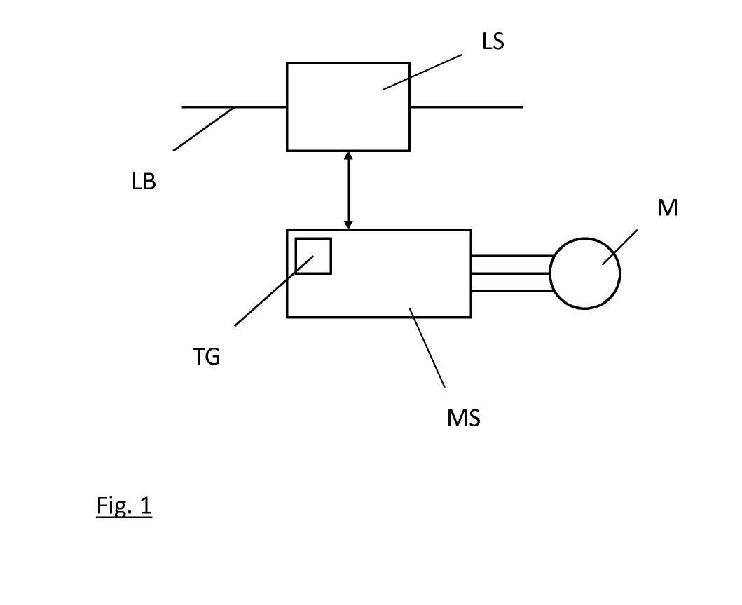

FIG. 1 illustrates a bus system LB which is embodied as an LIN bus and has a slave station LS. A motor controller MS is operatively connected to the vehicle electronics via a second slave station, an LIN slave LS (not illustrated). The motor controller MS is operatively connected to a brushless direct current motor and energizes the windings thereof in accordance with a position of the rotor position. A predetermined rotational speed value which is to be adopted is fed to the motor controller MS via the LIN bus LB and the LIN slave. The motor M may be the drive of a radiator fan, with the result that the motor and the controller are subjected to a corresponding temperature range.

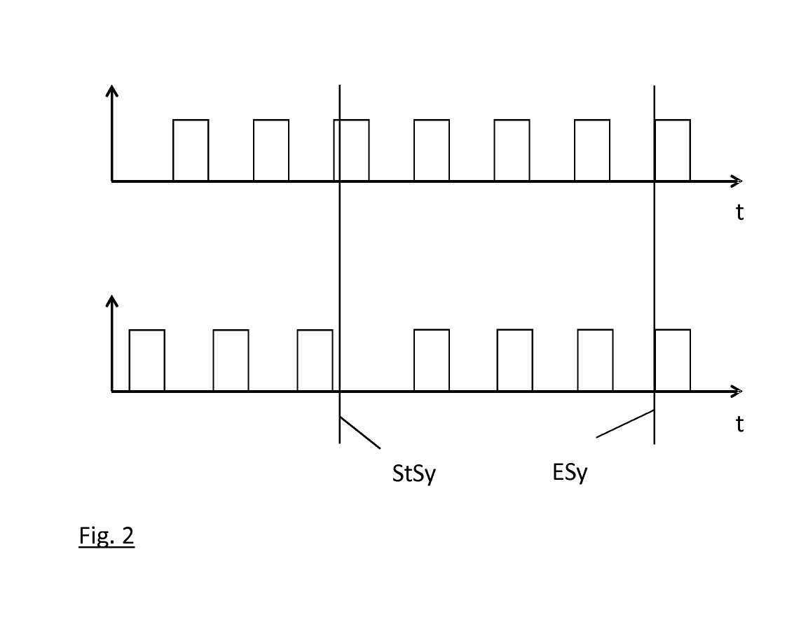

The motor controller MS has power output stages which are necessary to energize the windings of the motor M and the clock generator, TG, which is embodied as an RC oscillator. The clock generator of the motor controller MS is configured to generate a sequence of square wave pulses such as are illustrated below in FIG. 2, plotted against the time t.

The clock generator of the LIN master generates the pulse sequence, illustration plotted against time at the top of FIG. 2, with a high level of accuracy. The master clock is used via the LIN bus slave LS to synchronize the relatively inaccurate clock of the clock generator TG of the motor controller MS. The relatively inaccurate clock sequence of the motor controller MS is subjected phase-by-phase to the clocking of the LIN bus LB in such a way that at the start of the synchronization StSy phase synchronization takes place and at the time ESy the clocking is synchronized. The clock generator TG provides, for a specific time, a high quality clock signal. The synchronization process is repeated periodically.

The term “coupled” or “connected” may be used herein to refer to any type of relationship, direct or indirect, between the components in question, and may apply to electrical, mechanical, fluid, optical, electromagnetic, electromechanical or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the embodiments may be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

### LIST OF REFERENCE SIGNS

LB LIN bus, bus system
LS Slave, slave station, LIN bus slave
MS Motor controller
M Motor, brushless direct current motor
TG Clock generator, RC oscillator motor controller
t Time
StSy Start of synchronization
ESy End of synchronization

What is claimed is:

1. A motor controller for an electric motor of a motor vehicle, comprising:
electronics configured to bring about an energization of windings of the electric motor; and
a clock generator configured to send a clock signal which controls the electronics, wherein:
the motor controller is operatively connected to a slave of a bus system in order to transmit and/or receive signals; and
a clock of the clock signal provided by a bus master is used via the slave to synchronize the clock generated by the clock generator of the motor controller.

2. The motor controller of claim 1, wherein the bus system comprises an LIN bus.

3. The motor controller of claim 1, wherein the electric motor comprises a brushless direct current motor.

4. The motor controller of claim 1, wherein the clock generator comprises an RC oscillator.

5. The motor controller of claim 1, wherein the electric motor is configured to drive a radiator fan of the motor vehicle.

6. A system, comprising:
an electric motor; and
a controller having electronics configured to bring about an energization of windings of the electric motor, the controller including a clock generator configured to send a clock signal which controls the electronics, wherein:
the controller is operatively connected to a slave of a bus system in order to transmit and/or receive signals; and
a clock of the clock signal provided by a bus master is used via the slave to synchronize the clock generated by the clock generator of the controller.

7. The system of claim 6, wherein the bus system comprises an LIN bus.

8. The system of claim 6, wherein the electric motor comprises a brushless direct current motor.

9. The system of claim 6, wherein the clock generator comprises an RC oscillator.

10. The system of claim 6, wherein the electric motor comprises an electric motor for a motor vehicle.

11. The system of claim 10, wherein the electric motor is configured to drive a radiator fan of the motor vehicle.

12. A system for a motor vehicle, the system comprising:
a motor;
a controller operatively connected to the motor and having electronics configured to bring about an energization of windings of the motor, the controller including a clock generator configured to send a clock signal which controls the electronics; and
a bus system operatively connected to the controller,
wherein a clock of the clock signal provided by a bus master is used via the slave to synchronize the clock generated by the clock generator of the controller.

13. The system of claim 12, wherein the bus system comprises an LIN bus.

14. The system of claim 12, wherein the electric motor comprises a brushless direct current motor.

15. The system of claim 12, wherein the clock generator comprises an RC oscillator.

16. The system of claim 12, wherein the motor comprises an electric motor for the motor vehicle.

17. The system of claim 16, wherein the electric motor is configured to drive a radiator fan of the motor vehicle.
